(19) United States
(12) Patent Application Publication
(10) Pub. No.: US 2023/0073431 A1
(43) Pub. Date: Mar. 9, 2023

(54) SYSTEM AND METHOD FOR REDUCING DISPLAY ARTIFACTS

(71) Applicant: GOOGLE LLC, Mountain View, CA (US)

(72) Inventors: Yenyu Peng, New Taipei City (TW); Chao-Ching Hsu, Taipei City (TW); Wei-Chier Liao, Taoyuan City (TW); Hsi-Chieh Peng, New Taipei City (TW)

(21) Appl. No.: 17/760,246

(22) PCT Filed: Feb. 7, 2020
(86) PCT No.: PCT/US2020/017256

§ 371 Date: Aug. 5, 2022

(51) Int. Cl. G09G 3/3258; H04M 1/02; G09G 3/20

(52) U.S. Cl. CPC G09G 3/3258; G09G 3/2074; H04M 1/0266; G09G 2320/066; G09G 2320/0209; G09G 2320/0242; H04M 2250/12

(57) ABSTRACT

High resolution displays, such as OLED displays, utilize complex driving circuits that can suffer from crosstalk. The crosstalk can affect the brightness of pixels in a row the display, which can be observed by a viewer as a crosstalk artifact. The severity of a crosstalk artifact may correspond to a contrast ratio of a high-contrast transition in which vertically adjacent pixels are sequentially driven by different driving signals during a scan. When a contrast ratio is above a maximum-perceptible contrast ratio, reducing the contrast ratio to the maximum-perceptible contrast ratio and can reduce, or eliminate, crosstalk artifacts. Disclosed herein are methods and devices that adjust pixels to reduce a crosstalk artifact without having a noticeable effect on contrast.

### FIELD OF THE DISCLOSURE

The present disclosure relates to displays and more specifically to a display having artifacts from pixel crosstalk through a driving circuit.

### BACKGROUND

As active-matrix displays are made higher in resolution, driving circuits for each pixel in the active matrix may be required to physically fit into smaller areas for each pixel and with less spacing in between the smaller areas. Additionally, displays utilizing organic light-emitting diodes (OLEDs) or micro-LEDs as pixels may require complicated driving circuits (e.g., to reduce driving variation). These two requirements can increase a crosstalk between pixels due to a capacitive coupling. This crosstalk may generate perceptible artifacts when certain images are displayed. These perceptible artifacts may be undesirable to some users. It is in this context that implementations of the disclosure arise.

### SUMMARY

In at least one aspect, the present disclosure generally describes a method. The method includes analyzing an image for display on a display in order to detect a high-contrast transition between vertically adjacent rows of the display. The high-contrast transition between the vertically adjacent rows of the display includes at least one vertically adjacent pair of pixels that has a contrast ratio (luminance ratio of a darker pixel of the vertically adjacent pair and a lighter pixel of the vertically adjacent pair) that is above a threshold value. The method further includes reducing the contrast ratio of each vertically adjacent pair of pixels having a contrast ratio above the threshold. The method further includes displaying the image with the reduced contrast ratio between the at least one vertically adjacent pair of pixels in the high-contrast transition. The method may have the technical effect of at least reducing a crosstalk artifact in the displayed image because a crosstalk artifact can have a magnitude corresponding to the contrast ratio between the at least one vertically adjacent pair of pixels in the high-contrast transition.

The threshold value may be based on a maximum-perceptible contrast ratio corresponding to a measurement of a human’s ability to perceive contrast. Reducing the contrast ratio of each vertically adjacent pair of pixels having a contrast ratio above the threshold may include: reducing the contrast ratio to be equal to or below the maximum-perceptible contrast ratio. The maximum-perceptible contrast ratio may be approximately 1000: 1, and those skilled in the art will recognize that the threshold can be advantageously selected to be near that ratio to reduce artifacts while minimizing the impact on the contrast ratio. For example, the maximum-perceptible contrast ration may be 1000:1 or less. Reducing the contrast ratio of the vertically adjacent pair of pixels having a contrast ratio above the threshold may include: increasing a gray level of the darker pixel of the vertically adjacent pair of pixels and not adjusting a gray level of the lighter pixel of the vertically adjacent pair of pixels so that the contrast ratio of each of the vertically adjacent pair of pixels is the maximum-perceptible contrast ratio. Increasing the gray level of the darker pixel of the vertically adjacent pair of pixels may include: determining a minimum-required gray level corresponding to a minimum-required brightness of the darker pixel to achieve the maximum-perceptible contrast ratio between the darker pixel and the lighter pixel in the vertically adjacent pair of pixels; and increasing the gray level of the darker pixel of the vertically adjacent pair to the minimum-required gray level. Determining a minimum-required gray level corresponding to a minimum-required brightness of the darker pixel to achieve the maximum-perceptible contrast ratio between the darker pixel and the lighter pixel in the vertically adjacent pair of pixels may further include: sensing an ambient-light brightness using a sensor proximate to the display; determining a reflected-ambient-light brightness of the ambient-light brightness; and adjusting the minimum-required gray level based on the reflected-ambient-light brightness. Reducing the contrast ratio of the vertically adjacent pair of pixels having a contrast ratio above the threshold may include: decreasing a driving voltage of the darker pixel of the vertically adjacent pair of pixels and not adjusting the driving voltage of the lighter pixel of the vertically adjacent pair of pixels so that the contrast ratio of each of the vertically adjacent pair of pixels is the maximum-perceptible contrast ratio. Decreasing the driving voltage of the darker pixel of the vertically adjacent pair of pixels may include: determining a maximum-required driving voltage corresponding to a minimum-required brightness of the darker pixel to achieve the maximum-perceptible contrast ratio between the darker pixel and the lighter pixel the vertically adjacent pair of pixels; and decreasing the driving voltage of the darker pixel of the vertically adjacent pair to the maximum-required driving voltage. Determining a maximum-required driving voltage corresponding to a minimum-required brightness of the darker pixel to achieve the maximum-perceptible contrast ratio between the darker pixel and the lighter pixel the vertically adjacent pair of pixels may further include: sensing an ambient-light brightness using a sensor proximate to the display; determining a reflected-ambient-light brightness of the ambient-light brightness; and adjusting the maximum-required driving voltage based on the reflected-ambient-light brightness. The crosstalk artifact may include a row of pixels having pixel brightness levels that deviate from those prescribed by the image, an amount of the deviation can be greater than a threshold (e.g., a threshold corresponding to the magnitude of the crosstalk artifact).

In another aspect, the present disclosure generally describes a mobile computing device. The mobile computing device includes a display that includes driver circuits configured to drive a data line and a power line for each pixel in a row of pixels of the display. The mobile computing device also includes a memory and a processor configured by software instructions stored in the memory. The software instructions configured the processor to analyze an image for display on the display in order to detect a high-contrast transition between vertically adjacent rows of the display. The high contrast transition between the vertically adjacent rows of the display includes at least one vertically adjacent pair of pixels that has a contrast ratio (between a darker pixel of the vertically adjacent pair and a lighter pixel of the vertically adjacent pair) that is above a threshold. The software instructions further configured the processor to reduce the contrast ratio of each vertically adjacent pair of pixels having a contrast ratio above the threshold. The software instructions further configure the processor to display the image with the reduced contrast ratio between the at least one vertically adjacent pair of pixels in the high-contrast transition on the display. The reduction may reduce crosstalk between the data line and the power line for each pixel in a row of pixels for the display.

The threshold may be a maximum-perceptible contrast ratio corresponding to a measurement of a human’s ability to perceive contrast. To reduce the contrast ratio of each vertically adjacent pair of pixels having a contrast ratio above the threshold, the processor may be configured to: reduce the contrast ratio to the maximum-perceptible contrast ratio. For example, the maximum-perceptible contrast ratio may be approximately 1000:1 (e.g., 1000: 1 or less). To reduce the contrast ratio of the vertically adjacent pair of pixels having a contrast ratio above the threshold, the processor may be further configured to: increase a gray level of the darker pixel of the vertically adjacent pair of pixels and not adjust a gray level of the lighter pixel of the vertically adjacent pair of pixels so that the contrast ratio of each of the vertically adjacent pair of pixels is the maximum-perceptible contrast ratio. To increase the gray level of the darker pixel of the vertically adjacent pair of pixels, the processor may be further configured to: determine a minimum-required gray level corresponding to a minimum-required brightness of the darker pixel to achieve the maximum-perceptible contrast ratio between the darker pixel and the lighter pixel in the vertically adjacent pair of pixels; and increase the gray level of the darker pixel of the vertically adjacent pair to the minimum-required gray level. To determine the minimum-required gray level corresponding to the minimum-required brightness of the darker pixel to achieve the maximum-perceptible contrast ratio between the darker pixel and the lighter pixel in the vertically adjacent pair of pixels, the processor may be further configured to: sense an ambient-light brightness using a sensor proximate to the display; determine a reflected-ambient-light brightness of the ambient-light brightness; and adjust the minimum-required gray level based on the reflected-ambient-light brightness. To reduce the contrast ratio of the vertically adjacent pair of pixels having a contrast ratio above the threshold, the processor may be further configured to: decrease a driving voltage of the darker pixel of the vertically adjacent pair of pixels and not adjust the driving voltage of the lighter pixel of the vertically adjacent pair of pixels so that the contrast ratio of each of the vertically adjacent pair of pixels is the maximum-perceptible contrast ratio. To decrease the driving voltage of the darker pixel of the vertically adjacent pair of pixels, the processor may be further configured to: determine a maximum-required driving voltage corresponding to a minimum-required brightness of the darker pixel to achieve the maximum-perceptible contrast ratio between the darker pixel and the lighter pixel of the vertically adjacent pair of pixels; decrease the driving voltage of the darker pixel of the vertically adjacent pair to the maximum-required driving voltage. To determine the maximum-required driving voltage corresponding to the minimum-required brightness of the darker pixel to achieve the maximum-perceptible contrast ratio between the darker pixel and the lighter pixel of the vertically adjacent pair of pixels, the processor may be further configured to: sense an ambient-light brightness using a sensor proximate to the display; determine a reflected-ambient-light brightness of the ambient-light brightness; and adjust the maximum-required driving voltage based on the reflected-ambient-light brightness. The crosstalk between the data line and the power line may cause a crosstalk artifact in a displayed image, the crosstalk artifact including a row of pixels having pixel brightness levels that deviate from those prescribed by the image, an amount of the deviation corresponding to a magnitude of the crosstalk artifact. The display may be an organic light-emitting diode (OLED) display.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the invention. Aspects may be combined such that features described in the context of one aspect may be implemented in the context of the other aspect. The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates schematic of an active-matrix display according to a possible implementation of the present disclosure.

FIG. 2 is an example of a driving circuit for a pixel in an active-matrix display.

FIG. 3 is the driving circuit of FIG. 2 illustrating a possible parasitic capacitance.

FIG. 4 is a front view of a display displaying an example image with visible crosstalk artifacts.

FIG. 5 illustrates a portion of an active-matrix display at a high-contrast transition according to a possible implementation of the present disclosure.

FIG. 6A is an example image for display according to an implementation of the present disclosure.

FIG. 6B is an example gray level histogram for the image of FIG. 6A.

FIG. 6C is an example gamma curve for a display according to an implementation of the present disclosure.

FIG. 7 are images before and after a gray level adjustment for reducing crosstalk artifacts according to an implementation of the present disclosure.

FIG. 8 are driving-voltage curves before and after a driving-voltage adjustment for reducing crosstalk artifacts according to an implementation of the present disclosure.

FIG. 9 is a flowchart of a method for reducing a crosstalk artifact without changing a user’s perception of a high-contrast transition according to an implementation of the present disclosure.

The components in the drawings are not necessarily to scale relative to each other. Like reference numerals designate corresponding parts throughout the several views.

### DETAILED DESCRIPTION

The present disclosure describes a method for reducing (or eliminating) artifacts in a displayed image caused by crosstalk in a driving circuit for an active matrix display (i.e., a display). The disclosed approach recognizes that visible artifacts may result from high-contrast transitions between darker pixels and lighter pixels in a displayed image. The high-contrast transitions can require significantly different driving signal between scan lines (i.e. rows) of the display, which can lead to electrical coupling (i.e., crosstalk) between pixels. The disclosed approach further recognizes that reducing a contrast-ratio of the high-contrast transition can reduce (or eliminate) artifacts due to crosstalk (i.e., crosstalk artifacts). The disclosed approach further recognizes that adjusting the contrast-ratio may result in no perceptible degradation of the image if, after the reduction, a displayed contrast-ratio is still at, or above, a viewer’s limit in perception. In other words, no perceptible degradation results if the perceived contrast-ratio of a user (i.e., human, viewer, etc.) is unchanged after the reduction in the displayed contrast-ratio. Finally, the disclosed approach recognizes that an imperceptible reduction of the displayed contrast-ratio can reduce (or eliminate) the crosstalk artifact in the displayed image. Accordingly, a device (e.g., a mobile computing device) implementing the method for reducing (or eliminating) crosstalk artifacts may advantageously include a high-resolution display with complex driving circuits that would otherwise suffer from the effects (i.e., artifacts) of crosstalk.

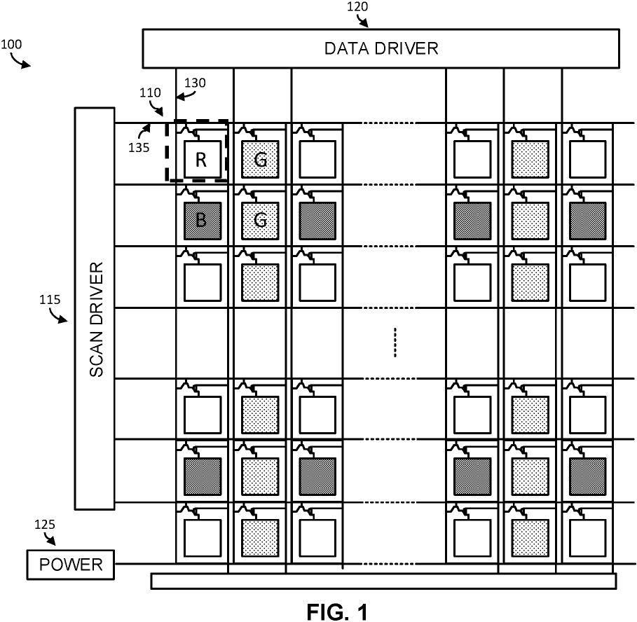

FIG. 1 illustrates a schematic of an active-matrix display (i.e., display). The display 100 includes pixels 110. In a color display (i.e., RGB display), each pixel may include subpixels representing the primary colors: red (R), green (G), and blue (B), such as shown in the figure. A black pixel may require each of the RGB subpixels to be fully illuminated. Accordingly, subpixels in a black (e.g., zero gray-level) pixel may require higher driving signals (e.g., voltages) than a white (e.g., maximum gray-level) pixel. For simplicity, subpixels are referred to simply as pixels in the disclosure. Additionally, gray scale artifacts and corrections are discussed exclusively because it is recognized that color artifacts and corrections can utilize the same (or similar) principles.

Each pixel of the display is driven independently by signals from a scan driver 115 and a data driver 120. In a scan, a row of pixels is activated by a switching signal transmitted from the scan driver 115 to a scan line 135. The switching signal couples each pixel in the activated row to the data driver 120 via a corresponding data line 130. The data driver 120 provides a data signal (e.g., driving voltage) to each pixel in the activated row causing it to transmit light at a level corresponding to the data signal. The scan of the display 100 sequentially activates each row of the display (e.g., from a top row to a bottom row). As vertically adjacent rows are activated in sequence, the illumination of pixels in previously activated rows can be maintained by a charged capacitor in a driving circuit for each pixel. Accordingly, a driving circuit for each pixel may include a capacitor and at least two (e.g., scan, data) switching devices (e.g., transistors).

The driving circuit for each pixel couples a light emitting element for the pixel to a data line. The light emitting element for each pixel may be implemented as an organic light emitting diode (OLED) or a micro light emitting diode (microLED). The data signal on a data line 130 configures the OLED or (microLED) to transmit light (i.e. illuminate) with brightness (i.e., luminance, intensity) corresponding to the data signal. For example, the data signal can be a driving voltage that configures a transistor of a driving circuit to conduct a current from a power supply 125 through the OLED (or microLED). While each pixel may receive a unique switching signal and data signal combination, all pixels may share a common signal (e.g., voltage) from the power supply 125.

The driving voltage on a data line can correspond to a gray level of an image pixel. For example, an 8-bit digital value for an image pixel may be transmitted by the data driver 120 as driving voltage in a range of 256 possible driving voltages. Further, a gray level of 255 (e.g., a white pixel) may correspond to a minimum driving voltage (e.g., <1 volts), while a gray level of 0 (e.g., a black pixel) may correspond to a maximum driving voltage (e.g., 5 volts). The driving voltages may change nonlinearly over the range of gray levels (e.g., 0 to 255). For example, to enhance contrast of the display, driving voltages may change more rapidly between lower gray levels (i.e. darker pixels) than between higher gray levels (i.e., lighter pixels).

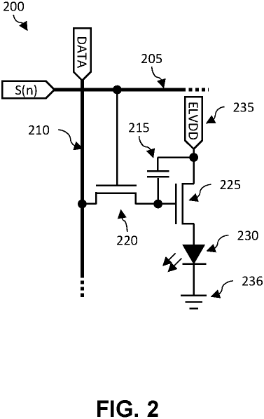

As mentioned, each pixel is controlled by a corresponding driving circuit. FIG. 2 is an example of a driving circuit for a pixel in an active-matrix display according to an implementation of the present disclosure. The driving circuit 200 consists of two transistors (e.g., thin film transistors TFTs) and a capacitor (i.e., is a 2T1C driving circuit). A controlling (i.e., gate) terminal of a first transistor 220 (i.e., a switching transistor) is coupled to a scan line 205 (i.e., S(n), where n = scan line number) and is configurable by a switching signal on the scan line 205 to couple/decouple a controlling (e.g., gate) terminal of a second transistor 225 (i.e., a driving transistor) to a data line 210 (i.e., DATA). When activated by the switching signal, a driving voltage on the data line controls the second transistor 225 to regulate a current through an OLED 230 (or microLED) that is provided by a power supply line (i.e., power line 235). A power supply coupled to the power line 235 may provide an upper level voltage (i.e. ELVDD) and a lower level voltage (i.e., ELVSS). For the example driving circuit shown in FIG. 2, the lower level voltage (ELVSS) of the power supply is a ground voltage 236. Additionally, the driving circuit 200 includes a capacitor 215 that can be charged to maintain the current through the OLED (or microLED) while other rows are activated during a scan.

The present disclosure is not limited to the example driving circuit 200 presented in FIG. 2, and in fact, it may be desirable implement a more complex driving circuit for improved performance. For example, a more complicated driving circuit may improve a pixel’s response to switching signals and/or data signals, especially in view of device variations. A more complex driver circuit can offer improved performance but requires more devices (e.g., transistors) and more lines for each pixel. The area allocated for a driver circuit can correspond to a pixel size and/or a pixel spacing. Accordingly, spacing between devices (and between driver circuits themselves) may be much smaller for a more complex driver circuit. Further, as the spacings in a driver circuit are reduced unwanted electrical signals in the driving circuits can cause visible artifacts (i.e., display artifacts) in a displayed image. The unwanted electrical signal may be the result of capacitive coupling between closely spaced portions of the driver circuit.

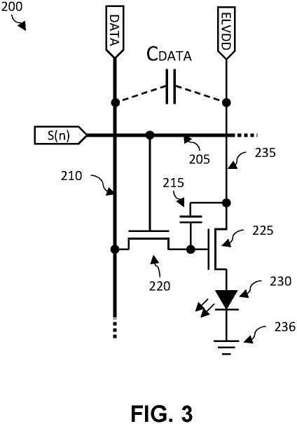

FIG. 3 illustrates the driving circuit of FIG. 2. Due to the complexity and the relatively small area for the driving circuit, there can exist electrical coupling between portions (i.e., nodes) of the driving circuit. The electrical coupling may result from a parasitic capacitance formed by, for example, a small spacing between nodes at different voltages. For example, signals (V_{DATA}) on a data line 210 may be coupled to signals (ELVDD) on a power line 235 by a parasitic capacitance (C_{DATA}). If the coupling and/or the signal (V_{DATA}) is large enough to alter the signals (ELVDD) on the power line 235, then all pixels sharing the power line may be driven to illuminate at pixel brightness levels (i.e., pixel levels) that deviate (e.g., elevated, diminished) from their prescribed gray level.

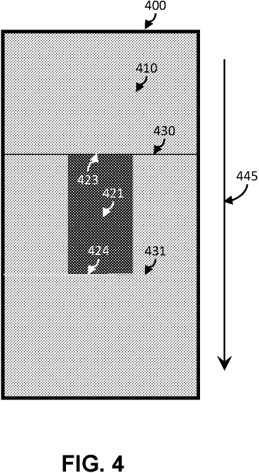

FIG. 4 illustrates a front view of an active matrix display, such as included in a mobile computing device (e.g., a mobile phone, tablet computer). The display 400 is shown presenting an example image that includes a black rectangle 421 on a gray background 410. The black rectangle 421 includes a plurality of pixels driven at a first gray level (e.g., gray level = 0) to have a first brightness, while the gray background 410 includes a plurality of pixels driven at a second gray level (e.g., gray level > 0) to have a second brightness. Brightness can be measured in “nits,” which is a unit of measurement of luminance, or the intensity, of visible light from the pixel (e.g., one nit is equal to one candela per square meter).

As described previously, the example image displayed is formed by sequentially driving rows of pixels (e.g., from a top row of the screen to a bottom row of the display). A high-contrast transition can be formed when pixels in a first row have a brightness (e.g., as measured in nits) that is significantly different (e.g., different above a predetermine value) than corresponding pixels in a second row that is adjacent to the first row. Because the difference in brightness corresponds to a difference in gray level and a difference in driving voltage, a high-contrast transition can also be characterized as a significant difference (e.g., different above a threshold) in gray levels between the adjacent rows or as a significant difference in driving voltages between the adjacent rows. For example, a contrast ratio between the black pixels of the black rectangle 421 and the gray pixels of the gray background 410 (i.e., between vertically adjacent pairs of pixels) at a border of the black rectangle 421 may define a high-contrast transition. As shown in FIG. 4, a first high-contrast transition 423 is formed between rows defining an upper edge of the black rectangle 421, and a second high-contrast transition 424 is formed between rows defining a lower edge of the black rectangle 421.

The first high-contrast transition 423 can cause a first crosstalk artifact 430 in the example image and the second high-contrast transition 424 can cause a second crosstalk artifact 431 in the example image. The first crosstalk artifact 430 and the second crosstalk artifact 431 can each appear as a row of pixels having gray levels (or colors) that are all elevated (i.e., increased) or diminished (i.e., reduced) from gray levels prescribed by the example image. For example, the first crosstalk artifact 430 can appear as a row of pixels that are darker than the gray background 410, while the second crosstalk artifact 431 can appear as a row of pixels that are lighter than the gray background 410. The appearance of the crosstalk artifacts may correspond to characteristics of the respective high contrast transitions.

A location and/or an alignment of a crosstalk artifact may correspond to a location and/or an alignment of a high-contrast transition. In the example image shown in FIG. 4, the first crosstalk artifact 430 is aligned and positioned according to the first high-contrast transition 423, and the second crosstalk artifact 431 is aligned and positioned according to the second high-contrast transition 424.

An amplitude of a crosstalk artifact can be defined as a difference (i.e., deviation) between an expected brightness of a prescribed gray level and an actual (e.g., perceived) brightness of a displayed gray level. An amplitude of a crosstalk artifact can correspond to a contrast ratio of a high-contrast transition. For example, a larger contrast ratio can create a crosstalk artifact having a higher amplitude (i.e., greater visibility). Additionally, an amplitude of a crosstalk artifact can correspond to a number of pixels in the high-contrast transition (i.e., length of the high-contrast transition). In the example image shown in FIG. 4, the amplitude of the first crosstalk artifact 430 may correspond to length, in pixels, of the upper edge of the black rectangle 421 and the amplitude of the second crosstalk artifact 431 may correspond to the length, in pixels, of the lower edge of the black rectangle 421. Additionally, the amplitude of the first and second crosstalk artifacts may correspond to a contrast ratio (i.e., gray level difference) between the gray level of the black rectangle and the gray level of the gray background.

The deviation between an expected brightness of a prescribed gray level and an actual (e.g., perceived) brightness of an actual gray level may have a signed aspect. For example, a crosstalk artifact may have a positive amplitude in which the gray level of a pixel appears brighter (i.e., lighter) than expected (i.e., prescribed), and a crosstalk artifact may have a negative amplitude in which the gray level of a pixel appears dimmer (i.e., darker) than expected (i.e., prescribed). In the example image shown in FIG. 4, the first crosstalk artifact 430 may be said to have a negative amplitude because the deviation makes the row pixels darker than expected, and the second crosstalk artifact 431 may be said to have a positive amplitude because the deviation makes the row pixels lighter than expected. The sign of the crosstalk artifact can depend on a direction of the scan (i.e., scan direction) with respect to a gray-level change at a high-contrast transition. In the example image shown in FIG. 4, as the example image is scanned along the scan direction 445, the gray-level changes from gray to black at the first high-contrast transition 423 and changes from black to gray at the second high-contrast transition 424. Accordingly, the first crosstalk artifact 430 and the second crosstalk artifact 431 have opposite signs.

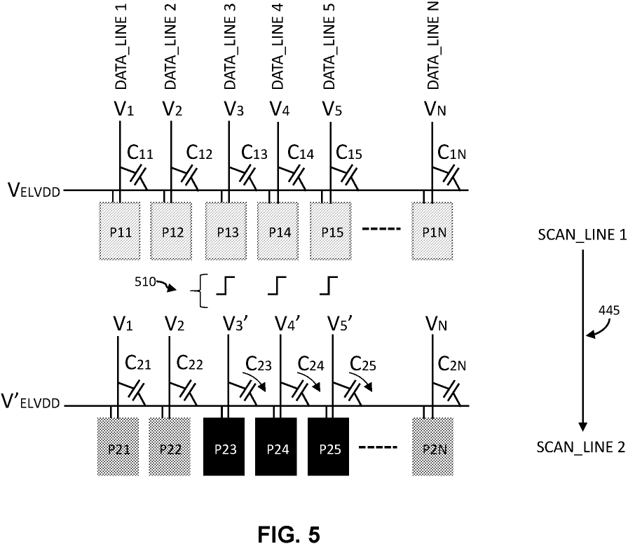

FIG. 5 illustrates a portion of an active matrix display at a high-contrast transition between a first scan line (i.e., row), SCAN_LINE 1, and a second scan line (i.e., row), SCAN_LINE 2. In the first scan line all pixels shown (i.e., P11, P12, P13, P14, P15, P1N) are driven at a first gray level (i.e., gray _level > 0). In the second scan line, some pixels are driven at the first gray level (i.e., P21, P22, P2N) but some pixels (i.e., P23, P24, P25) are driven at a second gray level (i.e. black, gray _level=0). A high-contrast transition is formed between pixels (P13, P14, P15) of the first scan line and pixels (P23, P24, P25) of the second scan line because, as the scan lines (i.e., rows) are activated along the scan direction 445, a large change in driving signals (e.g., a voltage step 510) is experienced.

As described previously, pixels of each row are connected to respective data lines when a scan line (i.e., row) is activated. When the scan progresses from the first scan line to the second scan line, the driving signals (e.g., driving voltages) on the data lines for some pixels (P21, P22, P2N) remains the same (i.e., V₁=V₁, V₂=V₂, V_{N}=V_{N}), but the driving voltages on the data lines associated with the pixels (P23, P24, P25) of the high-contrast transition changes by an amount corresponding to the contrast ratio of the gray level change (i.e., V₃'>V₃, V₄'>V₄, V₅'>V₅). Without any parasitic capacitance, the change in driving voltages can have little, or no, affect; however, when driver circuits in the display (not shown) have parasitic capacitances (e.g., C₂₃, C₂₄, C₂₅) that couple data lines to the shared power line, a power signal (V_{ELVDD}) may be changed by leakage (i.e., shown as arrows through capacitors C₂₃, C₂₄, C₂₅) caused by the voltage step 510. For example, a power line voltage may be increased (V_{ELVDD}'>V_{ELVDD}). Because the power line voltage determines a pixel brightness for a given driving signal, an altered power line voltage (V_{ELDD}') may correspond to a change in the brightness of the pixels in the row. As shown in FIG. 5, the brightness of some pixels (P21, P22, P2N) are affected (e.g., made darker) by the change in the power signal, thereby creating a crosstalk artifact.

The disclosed approach does not require an elimination of the parasitic capacitance (i.e., the crosstalk) because the driving signals (e.g., V₃', V₄', V₅') can be adjusted in a way to mitigate the crosstalk’s effect on an image. For example, reducing the voltage step 510 at the high-contrast transition reduces a change in the shared power signal, which in turn, reduces a crosstalk artifact (i.e., as perceived by a viewer). The disclosed approach recognizes that, under certain conditions, the driving signals can be adjusted to reduce a crosstalk artifact without affecting a user’s perception of the image.

Humans may accurately sense light over a range of light levels larger than ten orders of magnitude. Humans are less accurate in detecting contrast between two different light levels. For example, humans can accurately sense a contrast ratio between two light levels over a range of about 1:1 to about 1000: 1 (i.e., within 1 percent). In other words, humans can see (i.e., perceive) two areas of a display having a contrast ratio of 1000: 1 the same as two areas of a display having a contrast ratio of 1100: 1. Despite this, displays are routinely configured to display images having large contrast ratios that are greater than a maximum-perceptible contrast ratio, which may correspond to a measurement of a human’s ability to perceive contrast. The large contrast ratios may require driving signals (e.g., a voltage step 510) that can generate crosstalk artifacts. A contrast ratio of a high-contrast transition in excess of a maximum-perceptible contrast ratio can be reduced to approximately (e.g., within ± 5%) the maximum-perceptible contrast ratio (e.g., 1000: 1) to reduce or eliminate crosstalk artifacts without changing a viewer’s perception of the high-contrast transition.

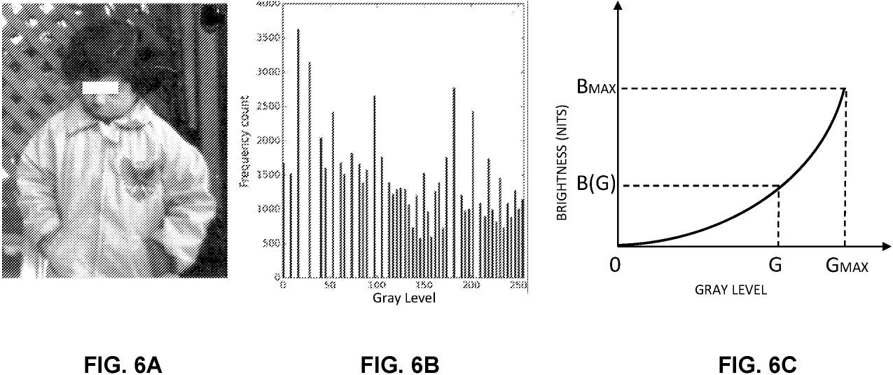

The reduction of the contrast ratio may require analyzing an image. FIG. 6A is an example image for display. The image is in gray scale, but the principles described may be applied to color images as well by considering the color components of the image separately. The image shown in FIG. 6A is an 8-bit gray scale image in which each pixel may be described by an 8-bit binary word. In other words, each pixel may have a gray scale value that is in a range of zero (e.g., a black pixel) to 2⁸-1 = 255 (e.g., a white pixel). FIG. 6B is a histogram representing the distribution of the gray levels of the pixels in the image and ranging from a gray level of zero to a maximum gray level (G_{MAX}) of 255. Each gray level of an image pixel may correspond to a brightness of a pixel in the display. A brightness of a pixel corresponds to a luminance or intensity of visible light transmitted by the pixel (e.g., as measured in nits). The brightness of a pixel can be related to a gray level of the pixel through a gamma curve. In other words, the gamma curve corresponds to a mathematical formula for converting a gray level to a brightness of the display (or vice versa). A possible gamma curve, described by the equation below, is shown in FIG. 6C.

$$B \left(G\right) = {B}_{M A X} ⋅ {\left(\frac{G}{{G}_{M A X}}\right)}^{2.2}$$

In the equation, the brightness (B) of the display at a gray level (G) can be determined as the maximum brightness (B_{MAX}) of the display multiplied by a ratio of the gray level (G) to a maximum gray level (G_{MAX}) of the image (e.g., 255) that is raised to a value (e.g., 2.2) corresponding to a gamma level. The maximum brightness (B_{MAX}) of a display may be a fixed value (i.e., a constant) based on the display’s design and/or operation. Further the maximum brightness may correspond to the highest gray level of the display (e.g., 255). An image may not use all gray levels. Accordingly, an image’s maximum gray level may be determined through an analysis of the image’s histogram (e.g., FIG. 6B). A corresponding pixel brightness (i.e., brightness) may be determined using a gamma curve (FIG. 6C) at the determined gray level. For example, an image determined (i.e., via a histogram) to have a maximum gray level of 160 corresponds to a maximum brightness of 150 nits (i.e., via equation (1)).

$$B \left(160\right) = 420 ⋅ {\left(\frac{160}{255}\right)}^{2.2} = 150 n i t s$$

For this example, the maximum brightness of the displayed image is 150 nits so pixels darker than 0.150 nits (i.e., darker pixels) will all be perceived as having similar contrast with the brightest pixels. Accordingly, the brightness of all darker pixels may be increased to 0.150 without any loss of perceived contrast. Further, this increase may reduce a voltage step 510 associated with a high-contrast transition, and the reduction may be small enough to reduce or eliminate visible crosstalk artifacts.

The adjustment of the darker pixels to reduce a contrast ratio of a high-contrast transition (i.e., reduce the high-contrast transition) may be carried out in a variety of ways. In a first implementation, a minimum-required brightness is calculated based on the maximum brightness of the display and the maximum perceivable contrast ratio (e.g., 1000: 1) of a human. All pixels having gray levels below the minimum-required brightness can be adjusted to have gray levels at the minimum required brightness.

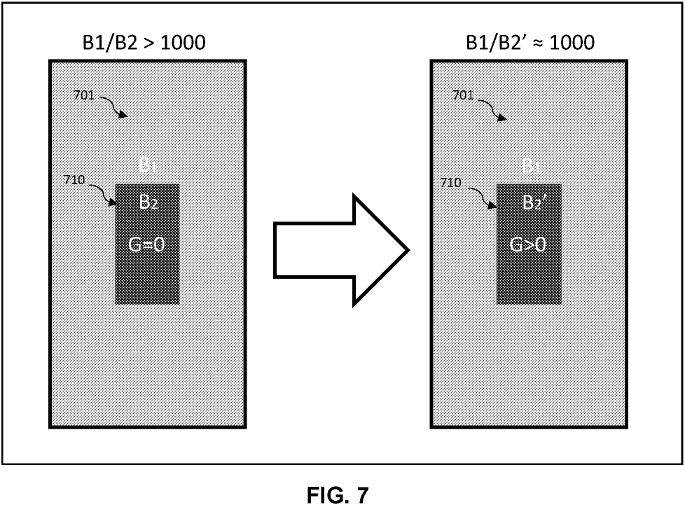

The example image of the black box on a gray background before and after the pixel adjustment is shown in FIG. 7. Before pixel adjustment (left image), the black box 710 has a gray level of zero (G=0). The gray background 701 includes pixels that are driven to radiate at a first brightness (Bi) and the black box 710 includes pixels that are driven to radiate at a second (lower) brightness (B₂). Before adjustment, the contrast ratio between the brightest pixels and the darkest pixels (i.e., B₁/B₂) is greater than a human eye can perceive (i.e., B₁/B₂ > 1000). After pixel adjustment (right image), the black box 710 has a gray level that is adjusted to be greater than zero (G>0) so that the black box 710 includes pixels that are driven to radiate at a third brightness (B₂') that is higher than the second brightness (i.e., B₂'>B₂). After adjustment, the contrast ratio between the brightest pixels and the darkest pixels is equal to the maximum-perceptible contrast ratio (B₁/B₂'≈1000).

In the first implementation, the adjustment may include changing gray levels of pixels in an image based on a calculated minimum-required brightness as shown in the equation below.

$${B}_{min \_ r e q u i r e d} = \frac{{B}_{max \_ i m a g e}}{C {R}_{max \_ p e r c e r i v a b l e}}$$

For example, a minimum-required brightness (B_{min_}_{required}) may be a maximum image brightness (B_{max_}_{image}) divided by a maximum-perceptible contrast ratio (CRₘₐₓ__{perceivable}), which can be, for some implementations, 1000: 1 but can be less (e.g., to reduce a crosstalk artifact at the expense of contrast ratio). After the minimum-required brightness is determined, a corresponding minimum-required gray level to achieve the maximum-perceptible contrast ratio may be determined based on a gamma curve/equation (e.g., equation (1)), and all pixels below the minimum-required gray level (i.e., darker pixels) can have their gray levels changed (i.e., adjusted) to the minimum-required gray level. In one possible implementation, the change includes changing gray levels of pixels in an image file. The first implementation reduces a range of possible gray levels in an image by raising all darker pixels to the minimum-required gray level. In a second implementation, the range of possible gray levels in an image is preserved after adjustment.

The second implementation includes changing driving signals (e.g., driving voltage) for the range of gray level voltages. As mentioned previously a black pixel (e.g., G=0) may have a higher driving voltage while a white pixel (e.g., G=255) may have a lower driving voltage.

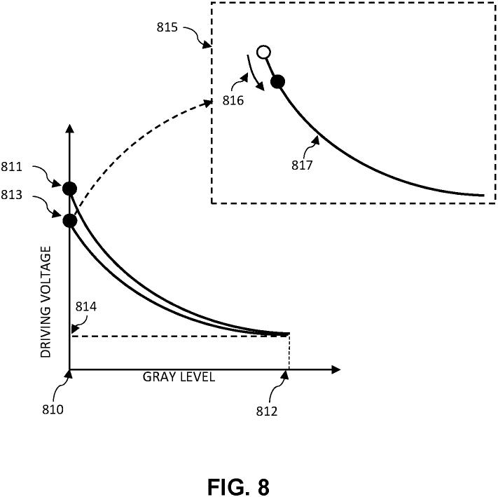

As shown in FIG. 8, a driving voltage may be related to the gray level by a driving-voltage curve 817. The driving-voltage curve may be similar to the gamma curve described previously. Before adjustment, a pixel at a minimum gray level 810 (e.g., G=0) may be driven at a first driving voltage 811 to produce a minimum brightness (i.e., black) and driven at a bright driving voltage 814 at a maximum gray level 812 (e.g., 255) to produce a maximum brightness (i.e., white). The minimum brightness of the image may be raised by decreasing (i.e., reducing) the first driving voltage 811 to a second driving voltage (i.e. a maximum-required driving voltage 813) at the minimum gray level 810. By maintaining the bright driving voltage 814 at the maximum gray level 812 before and after the adjustment, the contrast ratio of the image may be reduced.

An adjustment 816 of the driving voltage for minimum brightness is shown in the insert 815 of FIG. 8. After the minimum-required gray level (or brightness) is determined, a corresponding maximum-required driving voltage may be determined based on a driving-voltage curve, and all pixels driving with a voltage above the maximum-required driving voltage (i.e., darker pixels) can have their driving voltage changed (i.e., adjusted) to the maximum-required driving voltage. The adjustment to of the driving voltage to the maximum-required driving voltage may be implemented as a tuning point on the driving-voltage curve 817.

The maximum-perceptible contrast may also be affected by ambient light. Ambient light may cause a reflection off of a front surface of a display. When light is reflected off of the surface, small changes between dark pixels may be unnoticeable. Accordingly, dark (i.e., black) pixels may be adjusted to be brighter. For example, black pixels may be adjusted to a brightness corresponding to the reflected light. The reflected light may be determined as a percentage (e.g., 0% < percentage < 10%) of ambient light. Ambient light may be measured by a sensor proximate to (or integrated with) the display. For example, a mobile phone may utilize a light sensor (e.g., camera, photodetector) sharing a front surface of the mobile phone with the display. A light measurement from the sensor may be used to adjust brightness of the pixels in the display. The pixels may be adjusted a digital approach (e.g., the first implementation, FIG. 7) or an analog approach (e.g., the second implementation, FIG. 8)

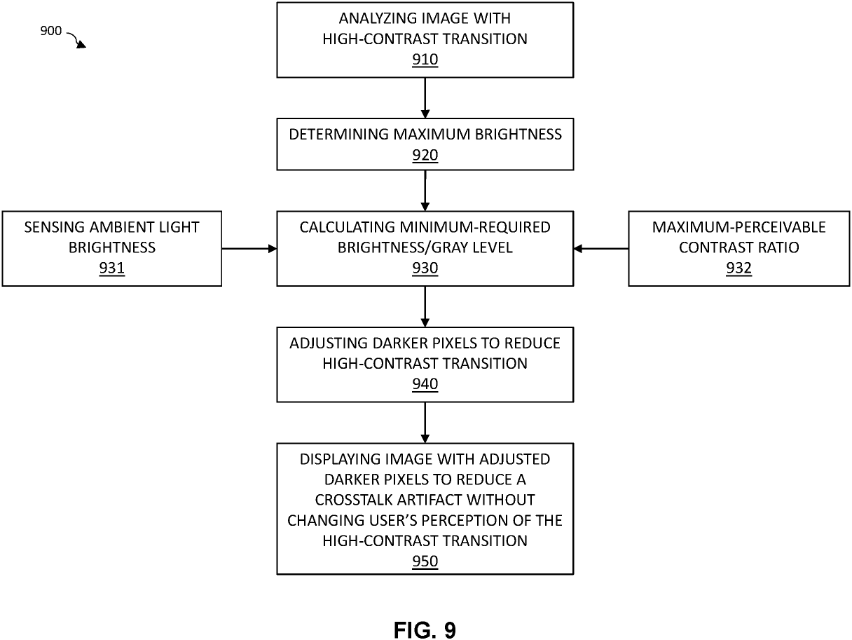

FIG. 9 is a flowchart of a method for reducing a crosstalk artifact without changing a user’s perception of a high-contrast transition according to an implementation of the present disclosure. In the method 900, an image for display (e.g., an active-matrix display) is received and analyzed 910 (e.g., using a histogram and gamma curve) to determine 920 a maximum brightness of the display (for the image). The method 900 also includes calculating 930 a minimum-required brightness based on the maximum brightness of the display and a maximum-perceptible contrast ratio 932. In some implementations, determining the minimum-required brightness is further based on sensing 931 an ambient light brightness (e.g., to determine a reflected-ambient-light brightness). Based on a gray level corresponding to the minimum required brightness (e.g., as determined by a gamma curve equation), darker pixels of the image may be adjusted 940 to reduce a contrast-ratio of the high-contrast transition to the maximum-perceptible contrast ratio. The adjustment may include adjusting gray levels of the darker (e.g., black) pixels of the image or adjusting driving signals corresponding to the darker pixels of the image. The method further includes displaying 950 the image with adjusted darker pixels to reduce a crosstalk artifact without changing a user’s perception of the high-contrast transition.

While the invention has been described with respect to two adjacent pixels, those skilled in the art will recognize that displays comprise multiple rows and columns of pixels. Accordingly, most pixels of a display have a vertically adjacent pixel above and below, and changing the contrast ratio of one vertical pixel pair can impact the contrast ratio of multiple pixel pairs. It is envisioned that whether to increase or decrease the brightness of any particular pixel in a pixel pair to reduce the contrast ratio of the pixel pair below the threshold will factor the contrast ratio of other pixel pairs, to maintain all (or most) vertically adjacent pixel pairs of the display below the contrast ratio threshold (e.g., below a maximum perceptible contrast ratio).

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
analyzing an image for display on a display to detect a high-contrast transition between vertically adjacent rows of the display, wherein the high-contrast transition between the vertically adjacent rows of the display includes at least one vertically adjacent pair of pixels that has a contrast ratio, between a darker pixel of the vertically adjacent pair and a lighter pixel of the vertically adjacent pair, that is above a threshold value;
reducing the contrast ratio of each vertically adjacent pair of pixels having a contrast ratio above the threshold; and
displaying the image with the reduced contrast ratio between the at least one vertically adjacent pair of pixels in the high-contrast transition.

2. The method according to claim 1, wherein the threshold value is based on a maximum-perceptible contrast ratio corresponding to a measurement of a human’s ability to perceive contrast.

3. The method according to claim 2, wherein reducing the contrast ratio of each vertically adjacent pair of pixels having a contrast ratio above the threshold includes:
reducing the contrast ratio to be equal to or below the maximum-perceptible contrast ratio.

4. The method according to claim 2, wherein the maximum-perceptible contrast ratio is approximately 1000:1.

5. The method according to claim 2, wherein reducing the contrast ratio of the vertically adjacent pair of pixels having a contrast ratio above the threshold includes:
increasing a gray level of the darker pixel of the vertically adjacent pair of pixels and not adjusting a gray level of the lighter pixel of the vertically adjacent pair of pixels so that the contrast ratio of each of the vertically adjacent pair of pixels is the maximum-perceptible contrast ratio.

6. The method according to claim 5, wherein increasing the gray level of the darker pixel of the vertically adjacent pair of pixels includes:
determining a minimum-required gray level corresponding to a minimum-required brightness of the darker pixel to achieve the maximum-perceptible contrast ratio between the darker pixel and the lighter pixel in the vertically adjacent pair of pixels; and
increasing the gray level of the darker pixel of the vertically adjacent pair to the minimum-required gray level.

7. The method according to claim 6, wherein determining a minimum-required gray level corresponding to a minimum-required brightness of the darker pixel to achieve the maximum-perceptible contrast ratio between the darker pixel and the lighter pixel in the vertically adjacent pair of pixels further includes:
sensing an ambient-light brightness using a sensor proximate to the display;
determining a reflected-ambient-light brightness of the ambient-light brightness; and
adjusting the minimum-required gray level based on the reflected-ambient-light brightness.

8. The method according to claim 2, wherein reducing the contrast ratio of the vertically adjacent pair of pixels having a contrast ratio above the threshold includes:
decreasing a driving voltage of the darker pixel of the vertically adjacent pair of pixels and not adjusting the driving voltage of the lighter pixel of the vertically adjacent pair of pixels so that the contrast ratio of each of the vertically adjacent pair of pixels is the maximum-perceptible contrast ratio.

9. The method according to claim 8, wherein decreasing the driving voltage of the darker pixel of the vertically adjacent pair of pixels includes:
determining a maximum-required driving voltage corresponding to a minimum-required brightness of the darker pixel to achieve the maximum-perceptible contrast ratio between the darker pixel and the lighter pixel the vertically adjacent pair of pixels; and
decreasing the driving voltage of the darker pixel of the vertically adjacent pair to the maximum-required driving voltage.

10. The method according to claim 9, wherein determining a maximum-required driving voltage corresponding to a minimum-required brightness of the darker pixel to achieve the maximum-perceptible contrast ratio between the darker pixel and the lighter pixel the vertically adjacent pair of pixels further includes:
sensing an ambient-light brightness using a sensor proximate to the display;
determining a reflected-ambient-light brightness of the ambient-light brightness; and
adjusting the maximum-required driving voltage based on the reflected-ambient-light brightness.

11. The method according to claim 1, wherein the image is one that, when displayed on the display without the reduced contrast ratio between the at least one vertically adjacent pair of pixels in the high-contrast transition, would include a crosstalk artifact having a row of pixels with pixel brightness levels that deviate from those prescribed by the image by an amount greater than a second threshold.

12. A mobile computing device comprising:
a display including driver circuits configured to drive a data line and a power line for each pixel in a row of pixels of the display;
a memory; and
a processor configured by software instructions stored in the memory to:
analyze an image for display on the display to detect a high-contrast transition between vertically adjacent rows of the display, wherein the high-contrast transition between the vertically adjacent rows of the display includes at least one vertically adjacent pair of pixels that has a contrast ratio, between a darker pixel of the vertically adjacent pair and a lighter pixel of the vertically adjacent pair, that is above a threshold;
reduce the contrast ratio of each vertically adjacent pair of pixels having a contrast ratio above the threshold; and
display the image with the reduced contrast ratio between the at least one vertically adjacent pair of pixels in the high-contrast transition on the display.

13. The mobile computing device according to claim 12, wherein the threshold is a maximum-perceptible contrast ratio corresponding to a measurement of a human’s ability to perceive contrast.

14. The mobile computing device according to claim 13, wherein to reduce the contrast ratio of each vertically adjacent pair of pixels having a contrast ratio above the threshold, the processor is configured to:
reduce the contrast ratio to the maximum-perceptible contrast ratio.

15. The mobile computing device according to claim 13, wherein the maximum-perceptible contrast ratio is approximately 1000:1 or less.

16. The mobile computing device according to claim 13, wherein to reduce the contrast ratio of the vertically adjacent pair of pixels having a contrast ratio above the threshold, the processor is further configured to:
increase a gray level of the darker pixel of the vertically adjacent pair of pixels and not adjust a gray level of the lighter pixel of the vertically adjacent pair of pixels so that the contrast ratio of each of the vertically adjacent pair of pixels is the maximum-perceptible contrast ratio.

17. The mobile computing device according to claim 16, wherein to increase the gray level of the darker pixel of the vertically adjacent pair of pixels, the processor is further configured to:
determine a minimum-required gray level corresponding to a minimum-required brightness of the darker pixel to achieve the maximum-perceptible contrast ratio between the darker pixel and the lighter pixel in the vertically adjacent pair of pixels; and
increase the gray level of the darker pixel of the vertically adjacent pair to the minimum-required gray level.

18. The mobile computing device according to claim 17, wherein to determine the minimum-required gray level corresponding to the minimum-required brightness of the darker pixel to achieve the maximum-perceptible contrast ratio between the darker pixel and the lighter pixel in the vertically adjacent pair of pixels, the processor is further configured to:
sense an ambient-light brightness using a sensor proximate to the display;
determine a reflected-ambient-light brightness of the ambient-light brightness; and
adjust the minimum-required gray level based on the reflected-ambient-light brightness.

19. The mobile computing device according to claim 13, wherein to reduce the contrast ratio of the vertically adjacent pair of pixels having a contrast ratio above the threshold, the processor is further configured to:
decrease a driving voltage of the darker pixel of the vertically adjacent pair of pixels and not adjust the driving voltage of the lighter pixel of the vertically adjacent pair of pixels so that the contrast ratio of each of the vertically adjacent pair of pixels is the maximum-perceptible contrast ratio.

20. The mobile computing device according to claim 19, wherein to decrease the driving voltage of the darker pixel of the vertically adjacent pair of pixels, the processor is further configured to:
determine a maximum-required driving voltage corresponding to a minimum-required brightness of the darker pixel to achieve the maximum-perceptible contrast ratio between the darker pixel and the lighter pixel the vertically adjacent pair of pixels; and
decrease the driving voltage of the darker pixel of the vertically adjacent pair to the maximum-required driving voltage.

21. The mobile computing device according to claim 20, wherein to determine the maximum-required driving voltage corresponding to the minimum-required brightness of the darker pixel to achieve the maximum-perceptible contrast ratio between the darker pixel and the lighter pixel the vertically adjacent pair of pixels, the processor is further configured to:
sense an ambient-light brightness using a sensor proximate to the display;
determine a reflected-ambient-light brightness of the ambient-light brightness; and
adjust the maximum-required driving voltage based on the reflected-ambient-light brightness.

22. The mobile computing device according to claim 12, wherein the image is one that, when displayed on the display without the reduced contrast ratio between the at least one vertically adjacent pair of pixels in the high-contrast transition, would include a crosstalk artifact due to crosstalk between the data lines and the power lines configured to drive the at least one vertically adjacent pair of pixels in the high-contrast transition, the crosstalk artifact including a row of pixels having pixel brightness levels that deviate from those prescribed by the image, wherein an amount of the deviation corresponds to a magnitude of the crosstalk artifact.

23. The mobile computing device according to claim 12, wherein the display is an organic light-emitting diode (OLED) display.
